(19) United States
(12) Patent Application Publication
(10) Pub. No.: US 2018/0010585 A1
(43) Pub. Date: Jan. 11, 2018

(54) DIRECT POWER GENERATION USING GRAVITY

(71) Applicant: Subhash Omkarmal Agarwal, Ahmedabad (IN)

(72) Inventor: Subhash Omkarmal Agarwal, Ahmedabad (IN)

(21) Appl. No.: 15/545,079

(22) PCT Filed: May 11, 2015
(86) PCT No.: PCT/IN2015/050035

§ 371 Date: Jul. 20, 2017

(30) Foreign Application Priority Data
Mar. 23, 2015 (IN) 952/MUM/2015

(51) Int. Cl. F03G 3/00; H02K 7/18; F03G 7/10

(52) U.S. Cl. CPC F03G 3/00; H02K 7/1853; F03G 7/10; Y10S 74/09

(57) ABSTRACT

The Conveyor1 will take the object vertically to the top of the device with speed control by the lifting unit (1), then the object will get transferred from Conveyor1 to Conveyor2. The Conveyor2 will carry the object to the free falling unit (2) area with speed control. The object will fall in the free falling area with the help of permanent magnets; the object will get attached on Conveyor3, which will give drive to the rotating wheel. The object gets detached from Conveyor3 and gets transferred to Conveyor4. Conveyor4 will take the object back to Conveyor1 with speed control. The falling object is again carry on the top and same cycle is continuously rotating the rotational wheel which further generate the electricity. By such way multiple devices are synchronized to give continuous power to the respective rotating wheel of each machine, wherein one main shaft passing through the rotating wheel of multiple machines.

### FIELD OF THE INVENTION

The present invention relates DIRECT POWER GENERATION USING GRAVITY. The generated electricity will be directly connected to the power grid through the generator device, which can be further used to run the other devices. The present invention relates to a direct power generation mechanism, and more particularly to a gravity power generation mechanism.

### BACKGROUND OF THE INVENTION

The currently available power generating devices generate electric power mainly through interaction between conductors and magnetic field. These power generating devices usually include a stator and a rotor rotatably arranged in the stator. The rotor is externally wound around by a plurality of induction coils, and the stator is provided on an inner wall surface with magnetic fields; or alternatively, a magnetic field is produced on the rotor and the stator is externally wound around by induction coils. When the rotor rotates, induction voltage is produced on the induction coils. The induction coil is externally connected to two conductors, so that electric current generated by the induction coil is transferred to other electric appliances for use.

The above-described power generating devices must be driven by hydraulic power or thermal power or be coupled with other rotary device for the rotor to rotate. That is, the conventional power generating devices tend to cause environmental disruption, air pollution or energy wasting, no matter in what manner the rotor of the power generating devices is driven to rotate. For instance, in the case of using thermal power to drive a conventional power generating device to generate electric power, it is necessary to continuously burn coal to generate thermal energy. In the process of burning coal, there would be constant waste gas emission to result in air pollution, making the power generating device environmentally hazardous.

Further, in the case of coupling a conventional power generating device with other rotary device to enable power generation, the rotary device must first be powered by some kind of energy source, such as electric power or gasoline, before it can drive the rotor of the power generating device to rotate. Therefore, the power generating device coupled with other rotary device apparently fails to meet the requirements of energy saving and environmental protection.

In brief, the conventional power generating devices have the following disadvantages: (1) unable to achieve effective energy saving; and (2) not environmentally friendly.

It is therefore tried by the inventor to develop a gravity-assisted self-rotating device and a power generating module using same to enable automatic generation of electric power and accordingly overcome the drawbacks of the conventional power generating devices.

### STATEMENT OF THE INVENTION

In the present invention, the quantity of the electricity may varies from the size of the machine. The generation of electricity is propose to the height of the machine and weight of the object. The present invention is divided in three part (1) lifting unit (2) free falling unit (3) Rotating Wheel unit.

In the lifting unit, heavy object is bring on top of the device.

In the free falling unit, the object is falling from the top and rotating wheel is rotating from the falling object.

In the present invention, the falling power is more compare to the lifting power. As the height of the machine is increase the falling object speed is increased continuously. The difference between the falling power and lifting power is utilized for the power generation.

### OBJECT OF THE INVENTION

A primary object of the present invention is to provide a gravity-assisted self-rotating device, which is able to automatically generate power output to achieve the purpose of energy saving.

The another main object of the present invention is to obviate the above mentioned prior-art problems.

Another object of the present invention is to provide a gravity-assisted self-rotating device, which is able to automatically generate power output to achieve the purpose of environmental protection.

With these arrangements, the gravity-assisted self-rotating device is able to automatically generate electric power output to achieve the purpose of energy saving and environmental protection.

The another object of the invention is to directly power generation using the gravity and which can be further connected to power grid.

The present invention system is structured at any remote location and the power generation in the present invention is environment friendly and free from the any hazardous air pollution.

The present invention is very efficient, long life, low maintenance and easily installable.

For a better-understanding of the invention, its operating advantages and the specific objects attained by its uses, reference should be had to the accompanying drawings and descriptive matter in which there is illustrated the preferred embodiments of the invention.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 represents the block diagram of the present invention device

FIG. 2 represents the flow diagram of the present invention device

### DETAILED DESCRIPTION OF THE INVENTION

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

In the present invention, the quantity of the electricity may varies from the size of the machine. The generation of electricity is propose to the height of the machine and weight of the object.

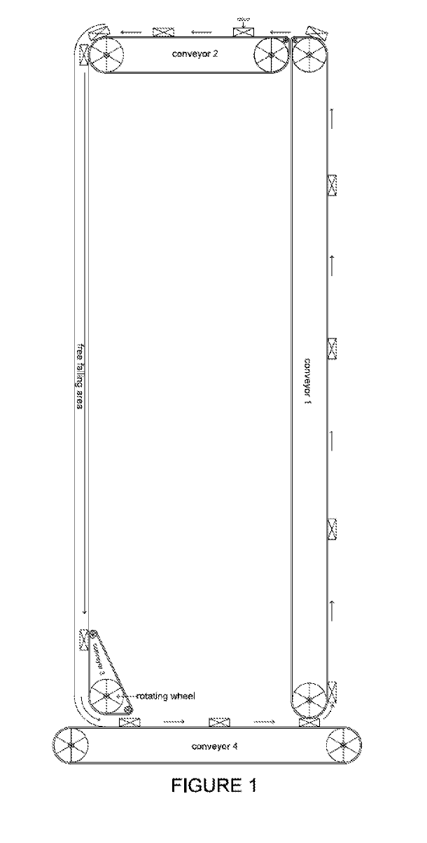

As show in FIG. 1 (1) the lifting unit (2) the free following unit (3) the Rotating Wheel unit is arranged as described in FIG. 1.

As shown in FIG. 1, Conveyor1 will take the object vertically to the top of the device with speed control by the lifting unit (1). Once the object is reached on the top, the object will get transferred from Conveyor1 to Conveyor2. Conveyor2 will carry the object to the free falling unit (2) area with speed control. The object will fall in the free falling area from a height of around 100 mts. The object will be controlled in the free falling area with the help of permanent magnets, facing the negative side of the object. The magnets will be installed on all four sides to enable the object to fall straight without any friction. The object will get attached on Conveyor3, which will give drive to the rotating wheel. The object gets detached from Conveyor3 and gets transferred to Conveyor4. Conveyor4 will take the object back to Conveyor1 with speed control. The speed control will be such that the object will give drive to Conveyor3 with the same speed repeatedly. The falling object is again carry on the top and same cycle is continuously rotating the rotational wheel which further generate the electricity.

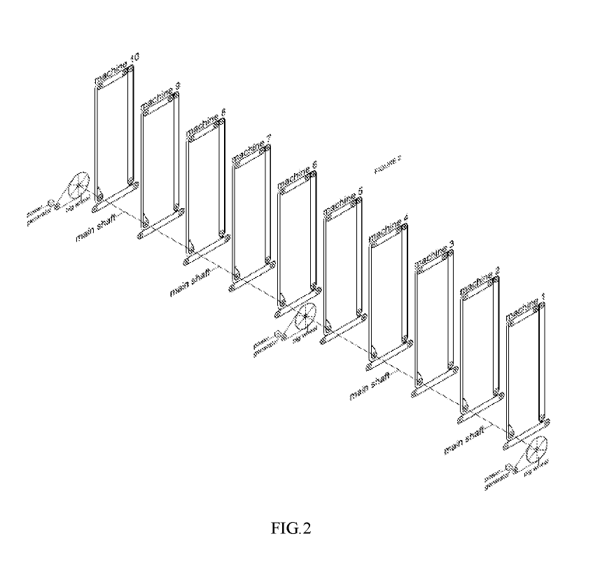

In the FIG. 2, the flow diagram of the present invention is described.

There will be multiple devices such as Machine1 placed consecutively. Objects will free fall in all the machines, with a certain time gap. The time difference will be such that all the machines will be synchronized to give continuous power to the respective rotating wheel of each machine. There will be one main shaft passing through the rotating wheel of each machine. All the rotating wheels of the machines will collectively give power to the main shaft. The main shaft will collectively give power to the big wheels. The big wheels will give power to the power generation devices. All the machines will be synchronized with speed control of the objects falling in each machine with a time difference between all the machines, such that there will always be an object falling on the top of conveyor 3 of either machines.

Further, the height and weight is varied and dependent on the requirement of the conversion of the gravity energy into electrical energy.

While, the invention has been described with respect to the given embodiment, it will be appreciated that many variations, modifications and other applications of the invention may be made. However, it is to be expressly understood that such modifications and adaptations are within the scope of the present invention, as set forth in the following claims.

I claim:

1. DIRECT POWER GENERATION USING GRAVITY consists with three unit
(i) lifting unit, (ii) free falling unit, (iii) rotating unit wherein Conveyor1 will take the object vertically to the top of the device with speed control by the lifting unit (1),
wherein the object is reached on the top, the object will get transferred from Conveyor1 to Conveyor2;
wherein Conveyor2 will carry the object to the free falling unit (2) area with speed control;
wherein the object will fall in the free falling area from a height of around 100 mts;
wherein the rotation wheels are provided on the bottom of the device to continuously rotate when it come in contact with the falling object from the top of the device;
wherein the object will get attached on Conveyor3, which will give drive to the rotating wheel and the object gets detached from Conveyor3 and gets transferred to Conveyor4;
wherein conveyor4 will take the object back to Conveyor1 with speed control and the speed control will be such that the object will give drive to Conveyor3 with the same speed repeatedly;
wherein the falling object is again carry on the top and same cycle is continuously rotating the rotational wheel which further generate the electricity.

2. DIRECT POWER GENERATION USING GRAVITY as claimed in claim 1 the object will be controlled in the free falling area with the help of permanent magnets, facing the negative side of the object.

3. DIRECT POWER GENERATION USING GRAVITY as claimed in claim 2 wherein the magnets will be installed on all four sides to enable the object to fall straight without any friction.

4. DIRECT POWER GENERATION USING GRAVITY as claimed in claim 1 wherein falling object is continuously bring on the top of the device to continuously rotating the wheels.

5. DIRECT POWER GENERATION USING GRAVITY as claimed in claim 1 wherein generated power is directly connected with the grid through the generator device.

6. DIRECT POWER GENERATION USING GRAVITY as claimed in claim 1 wherein generation of electricity is propose to the height of the machine and weight of the falling object.

7. DIRECT POWER GENERATION USING GRAVITY as claimed in claim 1 wherein the difference between the falling power and lifting power is used for power generation.

8. DIRECT POWER GENERATION USING GRAVITY as claimed in claim 1 wherein the multiple devices such as machine1 placed consecutively then objects will free fall in all the machines, with a certain time gap.

9. DIRECT POWER GENERATION USING GRAVITY as claimed in claim 8 wherein the time difference will be such that all the machines will be synchronized to give continuous power to the respective rotating wheel of each machine.

10. DIRECT POWER GENERATION USING GRAVITY as claimed in claim 1 wherein one main shaft passing through the rotating wheel of multiple machines to collect the power which is further transfer to power generation device through the big wheels.
